(19) United States
(12) Patent Application Publication
(10) Pub. No.: US 2009/0020238 A1
(43) Pub. Date: Jan. 22, 2009

(54) Single Piece Spacer Support

(76) Inventors: Horatiu Ion Barbulescu, Douglasville, GA (US); Jimmy D. Anderson, Brenham, TX (US); LaBraylon H. Allen, Cedartown, GA (US)

Correspondence Address: BAKER BOTTS, LLP, 910 LOUISIANA, HOUSTON, TX, 77002-4995, US

(21) Appl. No.: 11/778,399

(22) Filed: Jul. 16, 2007

(51) Int. Cl. E06B 9/58

(52) U.S. Cl. 160/321

(57) ABSTRACT

A novel spacer support for attachment of chain sprockets of dead axle rollup doors. The spacer support is comprised of three spacer tubes and a support member. The spacer tubes and the support member are all formed as a unitary part.

### BACKGROUND

The present invention relates to torque transmission mechanisms with roller chains, and more particularly, to a novel spacer support for attachment of chain sprockets of dead axle rollup doors.

Rollup or curtain doors are widely used in a variety of applications ranging from mini-storages to large warehouses and manufacturing facilities with entrances or other openings that may be up to 20 feet tall and wide. Such doors represent a convenient security closure and are operable in a fairly limited space, both in terms of the size of the door itself and the amount of space required to open and close it.

A dead axle rollup door consists of a flexible curtain, usually made of corrugated panels or hinged elements suspended from the drum wheels of a fixed axle assembly. This construction allows the door to be rolled up and stored in a cylindrical configuration at the top of the door opening. Vertical guides, typically made of formed galvanized steel or extruded aluminum, are usually mounted on the sides of the door opening and serve to guide the door as it moves up and down. The top of the flexible curtain is suspended from an axle assembly with drum wheels.

The axle of the door is fixed and cannot rotate. Drum wheels are typically installed on the axle through bearings that allow the drum wheels to have relative rotation with respect to the axle. The flexible curtain forming the door is suspended from the drum wheels and slides up by coiling onto the drum wheels as the drum wheels rotate around the axle. Consequently, the rollup door may be opened and closed by changing the direction of rotation of the drum wheels. The rollup doors are generally lightweight and can be opened and closed by manual or automatic operation.

Typically, the dead axle rollup doors also have a locking mechanism mounted thereon which may be as simple as a sliding bolt type lock. In a sliding bolt lock mechanism, the door may be locked by sliding the bolt into a locking engagement with the guide track or with other metal means which would prevent the door from being opened unless the bolt is disengaged. The bolt assembly may be locked using a simple padlock.

In many cases, the manual operation of a tall door is accomplished using a reduce drive with a roller chain. A manual chain hoist or a jackshaft motor is used in conjunction with the roller chain transmission. The roller chain transmission is usually installed between the end drum wheel and the manual chain hoist or jackshaft motor. In a dead axle rollup door, the driven sprocket for the roller chain is attached to the rotating part of the end drum wheel.

When the dead axle rollup door is opened or closed, the curtain coils on the drum wheel and usually has some side movement. Therefore, a spacer support is needed to attach the driven sprocket to the drum wheel and to space out this sprocket, allowing enough space for the curtain as it coils and moves laterally.

Furthermore, users in certain regions desire dead axle rollup doors with a high wind resistance. To achieve this end, windlocks are installed on the dead axle rollup door. Windlocks are usually fastened to the end of the curtain and lock onto the vertical guide (windbar), improving the door's wind resistance. However, when installed, the windlocks usually extend past the edge of the curtain. Therefore, a spacer support is necessary for attaching the driven sprocket to the end drum wheel in order to allow enough side space for the windlocks as the curtain coils onto the drum wheel.

Finally, a spacer support is needed for the roller chain transmission on roll up doors in order to provide adequate alignment of the drive and driven sprockets and thus of the roller chain. This alignment is critical to the optimal operation of the door.

FIG. 1 depicts a spacer support 10 in accordance with the prior art. The spacer support 10 comprises six pieces including three spacer tubes 12 held together by three struts 14. The spacer tubes 12 and struts 14 are assembled on site and are attached to the drum wheel 16 using bolts 18, flat washers 20, lock washers 22 and nuts 24.

The spacer supports currently used have several drawbacks. The current spacer supports comprise multiple pieces. Therefore, when installing the door in place, the multiple pieces must be assembled on site. This process is time consuming and labor intensive.

Another disadvantage of the current spacer supports is that the movement of its multiple pieces as it turns prevents a smooth torque transmission. Yet another drawback of the current spacer supports is their labor intensive and expensive manufacturing process. Because the spacer support consists of multiple pieces, the manufacturing process entails cutting, stamping and bending the individual pieces.

### SUMMARY

The present invention relates to torque transmission mechanisms with roller chains, and more particularly, to a novel spacer support for attachment of chain sprockets of dead axle rollup doors.

In one embodiment the present invention is directed to a spacer support for use in a rollup or curtain door comprising three spacer tubes, and a support member, wherein the spacer tubes and the support member are formed as a unitary part.

In another embodiment the present invention is directed to a spacer support for use in a rollup or curtain door comprising a coplanar triangular support member and a spacer tube at each corner of the support member wherein the triangular support member and the spacer tubes comprise a single body.

The features and advantages of the present invention will be apparent to those skilled in the art from the description of the preferred embodiments which follows when taken in conjunction with the accompanying drawings. While numerous changes may be made by those skilled in the art, such changes are within the spirit of the invention.

### BRIEF DESCRIPTION OF THE DRAWINGS

These drawings illustrate certain aspects of some of the embodiments of the present invention, and should not be used to limit or define the invention.

FIG. 1 is a spacer support in accordance with the prior art.

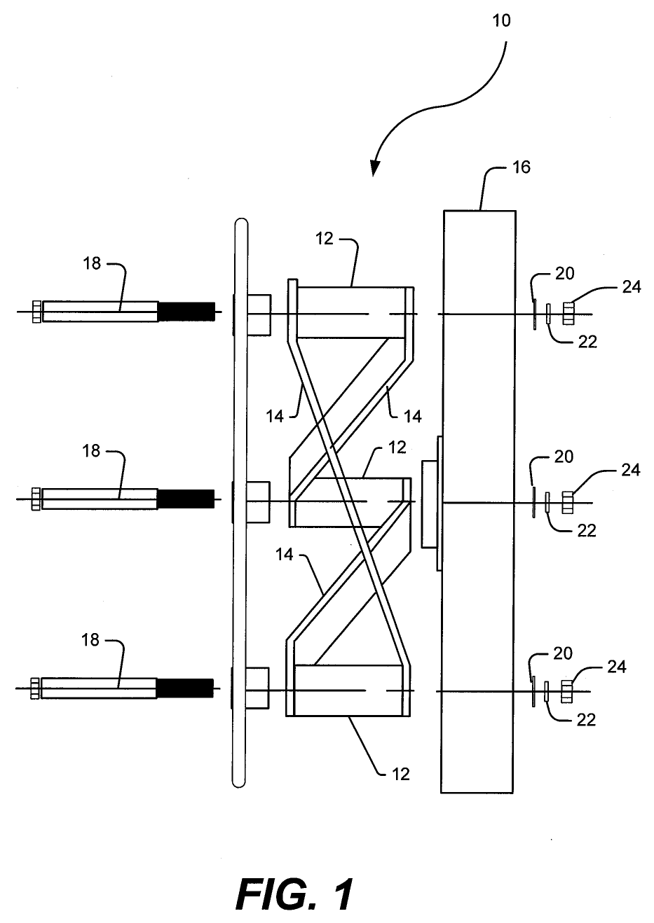

FIG. 2 is a dead axle rollup door with a single piece spacer support in accordance with an exemplary embodiment of the present invention.

FIG. 3 is a detailed view of the chain hoist assembly and single piece spacer support of FIG. 2.

FIG. 4A is a front view of a spacer support in accordance with an exemplary embodiment of the present invention.

FIG. 4B is a side view of the spacer support of FIG. 4A.

FIG. 5A is a front view of a spacer support in accordance with another exemplary embodiment of the present invention.

FIG. 5B is a side view of the spacer support of FIG. 5A.

### DETAILED DESCRIPTION

The present invention relates to torque transmission mechanisms with roller chains, and more particularly, to a novel spacer support for attachment of chain sprockets of dead axle rollup doors.

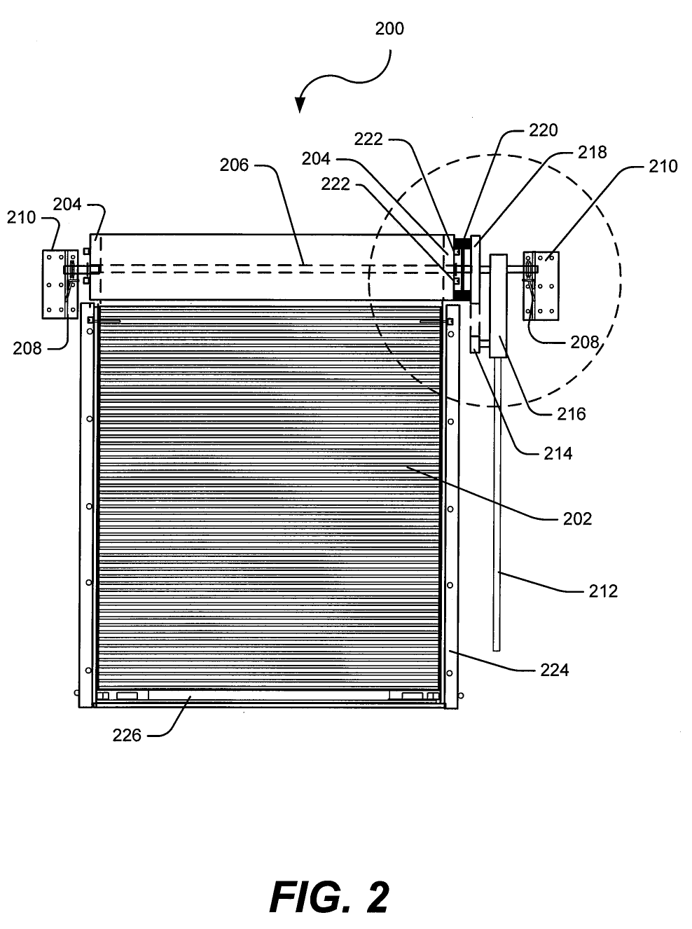

The details of the present invention will now be discussed with reference to the figures. Turning to FIG. 2, a dead axle rollup door having a single piece spacer support in accordance with an exemplary embodiment of the present invention is shown generally by reference numeral 200. The dead axle rollup door includes a curtain 202 suspended from the drum wheels 204. The drum wheels 204 are coupled to the door axle 206 such that they can rotate relative to the door axle 206. The door axle 206 is fixedly mounted onto brackets 208 and mounting plates 210 at its two ends.

The dead axle rollup door may be manually opened or closed by operating a chain 212. The chain 212 is coupled to the drive sprocket 214 of a chain hoist 216. The chain hoist 216 is in turn fixedly attached to the door axle 206. When the chain 212 is pulled, the drive sprocket 214 of the chain hoist 216 starts to rotate and drives a driven sprocket 218. The driven sprocket 218 is attached to drum wheel 204 through a single piece spacer support 220. As a result, when the driven sprocket 218 is set in motion by the drive sprocket 214, it rotates the drum wheels 204 relative to the door axle 206, which is fixed. Because the curtain 202 is suspended from the drum wheels 204 it will start to coil or uncoil, thus making the door open or close depending on the direction of rotation of the drive sprocket 214. The curtain 202 is directed by the guides 224 located on each side as it goes up and down. A bottom bar 226 is placed at the lower end of the door curtain 202.

The single piece spacer support 220 may couple the drum wheels 204 to the driven sprocket 218 through a variety of connections including, but not limited to, a connection formed with bolts, flat washers and nuts. In one exemplary embodiment bolts are inserted with the head in the side of the single piece spacer support 220 where the driven sprocket 218 is located and go through the spacer tubes of the single piece spacer support 220. The bolts are then fastened in place with nuts and flat washers from the inside of the drum wheels 204.

However, as discussed above, as the door is moved up or down, it tends to have some undesirable lateral movement. One role of the single piece spacer support is to space out the driven sprocket 218 from the drum wheels 204 to allow for some lateral movement of the curtain 202 without interrupting the door's operations.

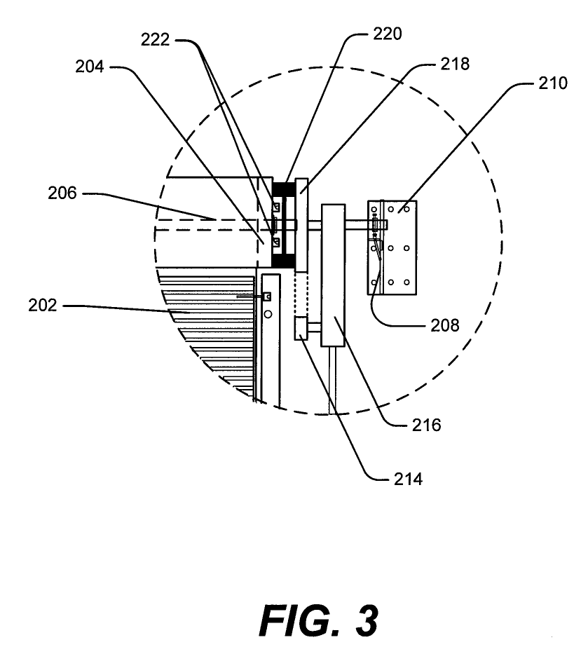

In some instances, a dead axle rollup door may also include windlocks 222. FIG. 3 depicts a detailed view of the chain hoist assembly and single piece spacer support of FIG. 2. As shown in FIG. 3, the windlocks 222 extend beyond the curtain 202 and the drum wheels 204. In order to ensure the proper operation of the driven sprocket 218 and prevent an interference from the windlocks 222, the single piece spacer support 220 is used to allow enough side space between the windlocks 222 of the curtain 202 and the driven sprocket 218.

Moreover, the correct alignment of the drive sprocket 214 and the driven sprocket 218 is critical to the correct operation of the dead axle rollup door 200. The position of the drive sprocket 214 is fixed through its connection with the chain hoist assembly 216 which is fixed onto the door axle 206. The single piece spacer support 220 provides adequate alignment of the drive sprocket 214 and the driven sprocket 218 by minimizing the driven sprocket's 218 lateral movement. The single piece spacer support 220 may have different designs depending on the diameter of the drum wheels 204.

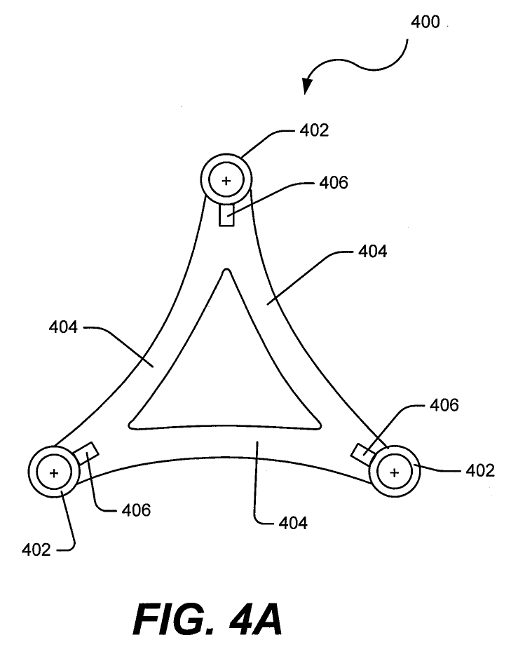

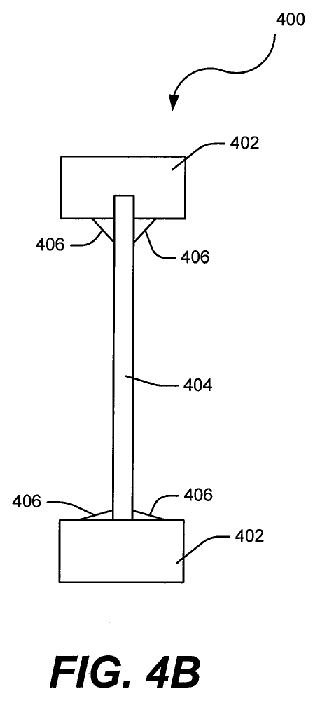

FIG. 4A depicts a front view of a single piece spacer support 400 for a drum wheel with a large diameter in accordance with an exemplary embodiment of the present invention. In one exemplary embodiment the diameter of the drum wheel is about 12 inches. The single piece spacer support 400 has a generally triangular shape and includes three spacer tubes 402 connected together by connecting arms 404. In one exemplary embodiment, the connecting arms 404 are substantially equal in size and form an equilateral triangle. The connecting arms 404 are bent slightly inwards, towards its center. The coplanar triangular shape provides a strong connection between the spacer tubes 402 and the bent sides allow easy access when mounting the single piece spacer support 220 onto the drum wheels 204. The connecting arms 404 are coplanar thereby improving the spacer support's ability to withstand stress loads.

As shown in the side view depicted in FIG. 4B, in one embodiment, a pair of strengthening ribs 406 are placed below each spacer tube 402 to further improve the single piece spacer support's 400 ability to withstand any stress loads incurred during torque transmission from the driven sprocket 218 to the drum wheels 204. The strengthening ribs 406 are placed on each side of the single piece spacer support 400. The spacer tubes 402, the connecting arms 404 and the strengthening ribs 406 are all formed as a unitary part. In one exemplary embodiment the different components of the single piece spacer support 400 are cast as a single part. In another exemplary embodiment the different components of the single piece spacer support 400 may be welded together to form a unitary part. In yet another exemplary embodiment the single piece spacer support 400 may be created by powder metallurgy. The unitary part arrangement includes any design that does not require the on site assembly of the spacer tubes, connecting arms or strengthening ribs.

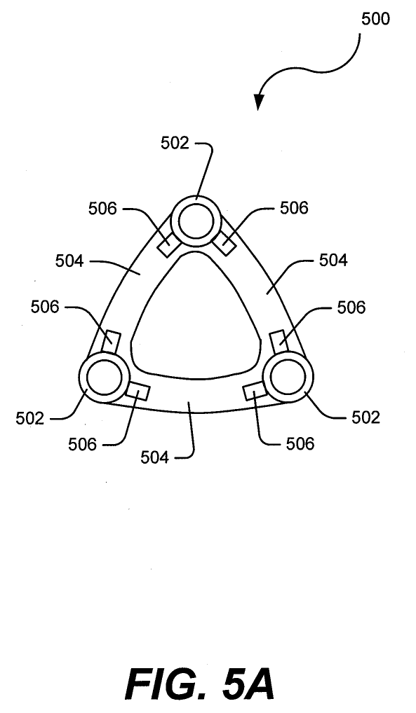

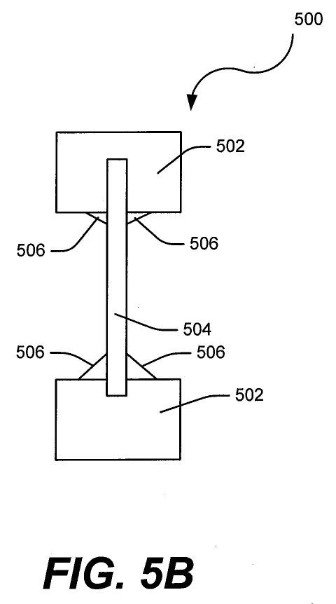

FIG. 5A depicts a front view of a single piece spacer support 500 for a drum wheel with a small diameter in accordance with an exemplary embodiment of the present invention. In one exemplary embodiment the diameter of the drum wheel is about 9.5 inches. The single piece spacer support 500 has a triangular shape with the connecting arms 504 bent slightly outwards, away from its center. In one exemplary embodiment the connecting arms 504 are substantially equal in size forming an equilateral triangle. The single piece spacer support 500 includes three spacer tubes 502 connected with each other via the three coplanar connecting arms 504. As discussed above, the coplanar arrangement of the connecting arms 504 allows the single piece spacer support to withstand high stress forces.

As shown in FIG. 5B, in one embodiment, strengthening ribs 506 are placed below each spacer tube 502 to further improve the single piece spacer support's 500 ability to withstand any stress incurred during torque transmission from the driven sprocket 218 to the drum wheels 204. In this exemplary embodiment four strengthening ribs 506 are provided for each spacer tube 502, two on each face of the single piece spacer support 500. The strengthening ribs 506 on each face are disposed along each connecting arm 504 attached to each spacer tube 502. The spacer tubes 502, the connecting arms 504 and the strengthening ribs 506 are all formed as a unitary part. In one exemplary embodiment the different components of the single piece spacer support 500 are cast as a single part. In another exemplary embodiment the different components of the single piece spacer support 500 may be welded together to form a unitary part. In yet another exemplary embodiment the single piece spacer support 500 may be created by powder metallurgy.

The single piece spacer support may comprise of any suitable material including, but not limited to, aluminum die cast, steel die cast, or welded steel. The single piece spacer support 220 has a compact design and functionally replaces the multiple piece spacers currently used. The coplanar triangular shape provides a strong connection between the spacer tubes and the bent sides allow easy access when mounting the single piece spacer support 220 onto the drum wheels 204. Finally, because the spacer support is made as a unitary part, the manufacturing and assembly processes are greatly simplified.

Although the present invention is described with reference to a manual dead axle rollup door, as would be appreciated by those of ordinary skill in the art, the single piece spacer support of the present invention may also be used with automatic rollup doors.

Therefore, the present invention is well-adapted to carry out the objects and attain the ends and advantages mentioned as well as those which are inherent therein. While the invention has been depicted and described by reference to exemplary embodiments of the invention, such a reference does not imply a limitation on the invention, and no such limitation is to be inferred. The invention is capable of considerable modification, alternation, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects. The terms in the claims have their plain, ordinary meaning unless otherwise explicitly and clearly defined by the patentee.

What is claimed is:

1. A spacer support for use in a rollup or curtain door comprising:
three spacer tubes, and
a support member,
wherein the spacer tubes and the support member are formed as a unitary part.

2. The spacer support of claim 1, wherein the support member comprises three coplanar connecting arms.

3. The spacer support of claim 2, wherein the connecting arms form a substantially equilateral triangle.

4. The spacer support of claim 2, wherein the connecting arms are bent inwards.

5. The spacer support of claim 4, further comprising a strengthening rib corresponding to each spacer tube formed on each face of the support member.

6. The spacer support of claim 2, wherein the connecting arms are bent outwards

7. The spacer support of claim 6, further comprising two strengthening ribs formed on each face of the support member corresponding to a spacer tube, wherein each of the two strengthening ribs formed on each face is formed along a connecting arm.

8. The spacer support of claim 2, wherein the connecting arms have substantially the same length.

9. The spacer support of claim 1, further comprising at least one strengthening rib at the junction of each of the three spacer tubes and the support member.

10. The spacer support of claim 1, wherein the spacer tubes and the supporting member comprise aluminum die cast, steel die cast, or welded steel.

11. A spacer support for use in a rollup or curtain door comprising:
a coplanar triangular support member, and
a spacer tube at each corner of the support member,
wherein the triangular support member and the spacer tubes comprise a single body.

12. The spacer support of claim 11, wherein each side of the coplanar triangular support member is bent inwards.

13. The spacer support of claim 12, further comprising a strengthening rib corresponding to each spacer tube formed on each face of the support member.

14. The spacer support of claim 11, wherein each side of the coplanar triangular support member is bent outwards.

15. The spacer support of claim 14, further comprising two strengthening ribs formed on each face of the support member corresponding to a spacer tube, wherein each of the two strengthening ribs formed on each face is formed along a side of the coplanar triangular support member.

16. The single piece spacer support of claim 11, further comprising a strengthening rib between the spacer tubes and the triangular support member.
